(19) United States
(12) Patent Application Publication
(10) Pub. No.: US 2016/0203451 A1
(43) Pub. Date: Jul. 14, 2016

(54) SYSTEM AND METHOD FOR PROVIDING CONTROLLING SURCHARGE FEES CHARGED AT A COLLECTION OF ATMS

(71) Applicant: Cardtronics, Inc., Houston, TX (US)

(72) Inventors: Justin Upton, Houston, TX (US); Purvesh Patel, New York, NY (US); Ronald Moore, Prosper, TX (US); William P. Knoll, Cypress, TX (US)

(73) Assignee: Cardtronics, Inc., Houston, TX (US)

(21) Appl. No.: 14/594,968

(22) Filed: Jan. 12, 2015

(51) Int. Cl. G06Q 20/10; G06Q 20/34; G06Q 20/38; G06Q 20/36

(52) U.S. Cl. CPC G06Q 20/1085; G06Q 20/3672; G06Q 20/34; G06Q 20/38

(57) ABSTRACT

Methods, systems, and computer storage are disclosed herein that operate to implement and manage an ATM membership service across a collection of participating ATM machines. The ATM membership service provides its registered members surcharge-free access to the participating ATMs. User can register and pay a fee to become members. Once registered, their financial transactions at ATMs are monitored and allowed to occur at participating ATMs surcharge free by checking tokens generated from the swiped or inserted ATM cards.

### BACKGROUND

The automatic teller machine (ATM) has been around for decades, providing ATM users round-the-clock access to cash. Instead of having to visit a brick-and-mortar bank to retrieve cash, make withdrawals, or check account balances, ATMs allow users to freely perform such functions at kiosk-type automated machines virtually anywhere. ATMs traditionally charge a surcharge fee for users to perform the above functions, but the cost of processing a transaction through a live teller is much more expensive to a financial institution than simply letting an ATM do the same. A significant percentage of all financial transactions are now done through an ATM.

The increase in ATM usage and availability was facilitated by the opening of shared ATM networks. ATM fleets operated by financial institutions were proprietary networks that were available to only their own customers. The development of electronic funds transfer (“EFT”) networks helped made way for increased ATM usage and availability. An EFT network is a network that has connections with financial institutions to allow electronic transfer of funds between those participating member financial institutions. Financial institutions often allow their customers to use ATMs owned or operated by another financial institution so long as the user's institution, or the ATM, are members of the same EFT network.

A side-effect of the new open networks was the advent of the surcharge fee, a fee charged to the consumer for the convenience of using an ATM owned by any entity other than the consumer's financial institution. ATM surcharging became widespread in the 1990's when the national EFT networks changed their policies to allow surcharging at ATMs. The change in surcharge policy has resulted in the rapid deployment of ATMs at off-premise or off-branch locations. While the massive deployment of ATMs has made accessing one's financial institution account more convenient, as a whole, it has created many inconveniences to a large portion of customers who must pay surcharges every time they use another financial institution's ATM.

Generally, ATM users will seek out ATMs that have minimum, preferably zero, transaction costs. However, if the benefits of a low cost transaction with an ATM are outweighed by the costs of inconvenience (e.g., distance to travel, effort to find, etc.) for using that ATM, the user will typically use the out-of-network ATM for a fee. Thus, convenience has a price as well.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

One embodiment is directed to a method for controlling the presentation of a user interface (UI) window for charging a transaction surcharge fee on an automated teller machine (ATM). The method includes receiving an ATM card number and a date of a requested ATM transaction. An alphanumeric token is created through application of a hashing or encryption algorithm to the ATM card number. A determination is made as to whether the token is associated with a registered ATM card in an ATM membership service that provides surcharge-free usage of the ATM. If so, a membership timeframe associated with the token is checked to determine whether the membership associated with the token has lapsed. If the token is registered with the ATM membership service and the date of the requested ATM transaction is within a membership timeframe associated with the token, the ATM is directed to carry out the transaction without payment of a surcharge fee.

Another embodiment is directed to a method for controlling the presentation of a UI window for charging a transaction surcharge fee on an automated teller machine (ATM). The method includes receiving an ATM card number and a date of a requested ATM transaction either at an ATM or at a membership server. An alphanumeric token of the ATM card number is created through application of a hashing or encryption algorithm to the ATM card number. A determination is made as to whether the token is associated with a registered ATM card in an ATM membership service that provides surcharge-free usage of the ATM. If so, a membership timeframe associated with the token is checked to determine whether the membership associated with the token has lapsed. If the token has not been registered with the ATM membership service or the date of the requested ATM transaction is outside a membership timeframe associated with the token, the ATM is directed to carry out the transaction only upon acknowledgment to pay a surcharge fee.

Still another embodiment is directed to a system for managing an ATM membership service. The system includes a plurality of ATMs configured to receive ATM card numbers from ATM users. One or more servers are configured to store membership information in an ATM membership service for a plurality of ATM users; wherein, the membership information for each ATM user comprises a token value that is generated from a sixteen digit ATM card number and a membership timeframe during which the sixteen digit ATM card number enrolled in the ATM membership service. The one or more servers are also configured to receive each of the ATM card numbers from the plurality of ATMs and control the charging of surcharge fees on the plurality of ATMs based on valid enrollment of the ATM card numbers in the ATM membership service.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 illustrates a self-service device computing device in the form of an ATM, according to one embodiment;

FIG. 3 is a block diagram of a networking environment configured to manage a server-implemented ATM membership service that controls the charging of ATM surcharge fees across a selective collection of ATMs, according to one embodiment;

FIG. 4 illustrates a networked environment in which a registering member can register one or more ATM cards to participate in an ATM membership service, according to one embodiment;

FIG. 5 illustrates a web page for monitoring usage of an ATM membership service, according to one embodiment; and

FIG. 6 illustrates a flowchart diagram for a software-implemented work flow to control the charging of surcharge fees on a collection of ATMs in an ATM membership service, according to one embodiment.

### DETAILED DESCRIPTION

The subject matter of the present invention is described with specificity herein to meet statutory requirements. The description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention generally relate to systems, methods, and computer-storage media configured to manage and run a cloud-managed membership program and correspondingly control a network of ATMs based on user's membership enrollment. Users sign up to enroll in an ATM membership service that allows them to access and use a select group of ATMs without having to pay a surcharge fee. As previously discussed, a standard ATM typically charges surcharge fees to users using the ATM who are not customers of the financial institution operating the ATM—or who are not customers of a financial institution that has partnered with the ATM's host financial institution. One embodiment allows ATM users to enroll in the ATM membership service through a web page or software application to give them surcharge-free access to a collection of ATMs. One or more servers monitor ATM users are the collection of surcharge-free ATMs and instruct the ATM to not charge surcharge fees from out-of-network users who are enrolled in the ATM membership service.

The ATM membership service may require enrolling ATM users pay a membership fee—either initially or periodically (e.g., daily, weekly, monthly, annually, etc.)—to enroll or stay active in the service. Use of the cards of enrolled ATM users in the ATM membership service is monitored to determine whether they are accessing an ATM in the ATM membership. If so, the ATM is instructed by a server to not charge the ATM customer a surcharge fee. If not, the ATM can proceed with charging the surcharge fee.

Before proceeding, a number of key definitions should initially be clarified to aid one skilled in the art to understand the various embodiments discussed herein. An “ATM membership service” refers to a participation program whereby an enrolled ATM user can access a select, pre-defined group of operating ATMs at various locations on a surcharge-free basis upon enrollment in the service. The ATM membership service distinguishes between “participating ATMs” and “non-participating ATMs.” A participating ATM means any ATM that the ATM membership service provides surcharge-free access to, and a non-participating ATM is an ATM that a registered user of the ATM membership service still must pay a surcharge fee to use. In other words, the ATM membership service provides surcharge-free usage of participating ATMs, not non-participating ATMs.

An “account number” or “bank account number” refers to any issuer identification number for a financial institution customer. Examples of such account numbers include, without limitation, a bank identification number (BIN), primary account number (PAN), 16-digit debit or credit card number, gift card number (including all general purpose reloadable (GPR) and prepaid cards), or the like. Similarly, a “token account number” refers to a tokenized alphanumeric representation of an account number after application of a non-reversible, one-way hashing, encryption, or tokenizing algorithm. Such an algorithm may involve a private key, public key, public-private key pair of the like.

A “membership timeframe” refers to the beginning and ending dates in which a member is registered to participate in the ATM membership service. For example, the membership timeframe may include a beginning date the member registered to participate in the ATM membership service and an ending date at which time the membership terminates.

A “registering member” is a person who is registering one or more ATM cards for participation in the ATM membership service. As disclosed in more detail below, the registering member may register ATM cards on a laptop, personal computer, smartphone, mobile tablet, or similar type of computing device. Registered users of the ATM membership service are referred to as “registered members” herein.

Having briefly described an overview of embodiments of the present invention, an exemplary operating environment suitable for implementing the present invention is described below.

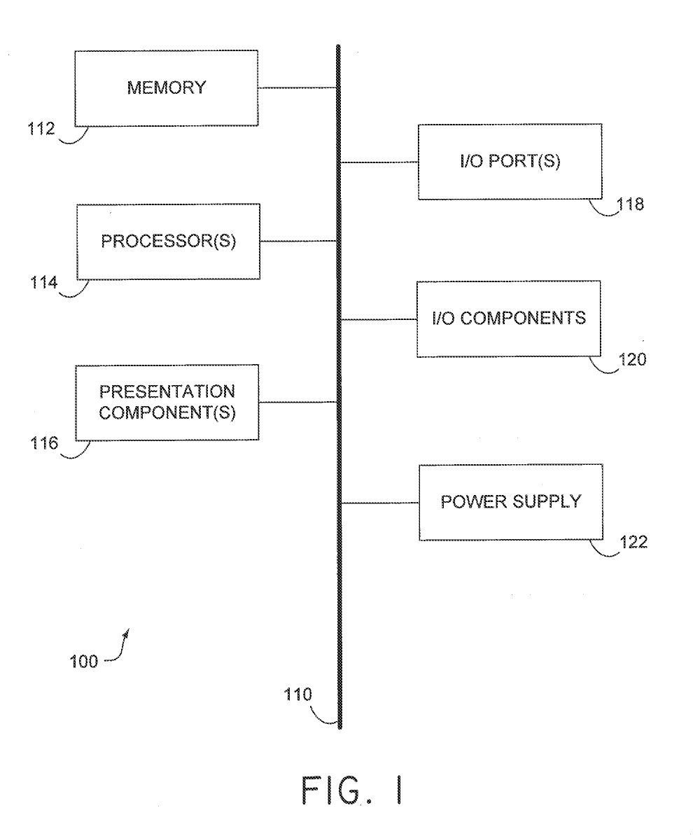

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of components illustrated.

Different embodiments of the invention may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. Embodiments of the present invention may be practiced in a variety of system configurations, including hand-held devices, consumer electronics, general-purpose computers, specialty computing devices, etc. Embodiments of the invention may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation components 116, input/output (I/O) ports 118, I/O components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” “tablet,” “server,” “smartphone,” etc., as all are contemplated within the scope of FIG. 1 and references herein to a “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVDs) or other optical or holographic media; magnetic cassettes, magnetic tape, magnetic disk storage or other magnetic storage devices, or any other medium that can be used to encode desired information and be accessed by computing device 100.

Memory 112 includes computer storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc. I/O ports 118 allow computing device 100 to be logically coupled to other devices including I/O components 120, some of which may be built in.

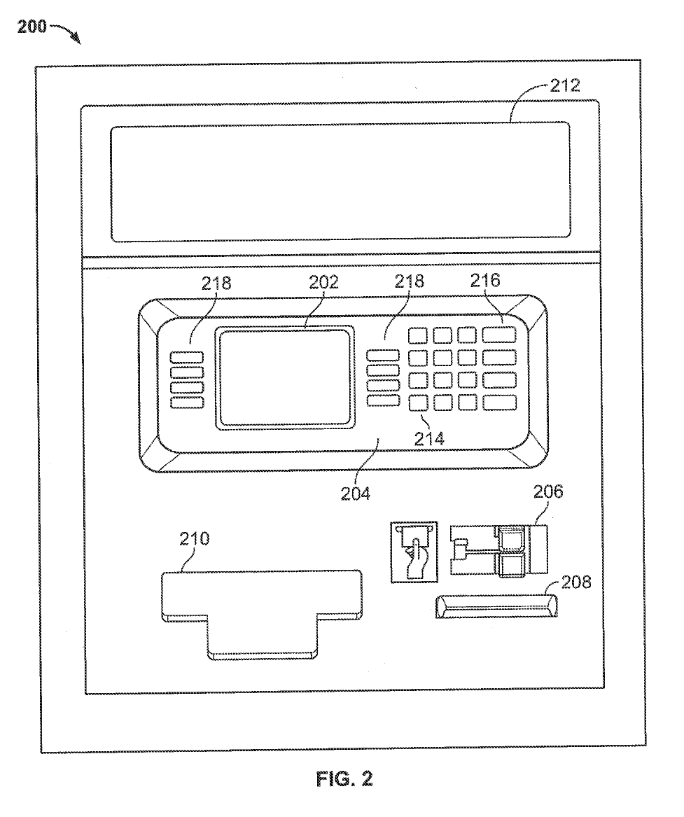

FIG. 2 illustrates an ATM 200 in accordance with one embodiment. ATM 200 includes monitor 202, keypad 204, card reader port 206, document acceptor 208, item dispenser 210 and security screen 212. Monitor 202 may exchange visual and or audio information with a customer. Keypad 204 may include alphanumeric keys 214 for the customer to enter numerical and textual data. Keypad 204 may include control keys 216. In some embodiments, control keys 216 may be used to communicate control information, such as instructions, to self-service device 200. Keypad 204 may include soft keys on a touch screen display that have software-controlled functions that are presented to the customer.

Card reader port 206 may be the front end of any suitable card reader. The card reader may read magnetically encoded information on transaction instruments such as bank cards. The transaction instrument may also be a chip, an RFID tag, a smart card, a PDA, a mobile phone or any other suitable device. In some embodiments, self-service device 200 may also include (not shown) a contactless chip reader, a wireless transceiver, a near field communications (NFC) transceiver, a barcode reader or any other suitable receiver and/or interface configured to exchange and/or receive information from a transaction and/or electronic instrument. The information exchanged and/or received may include user identification information, transaction information or any other suitable information.

In some embodiments, ATM 200 may include a biometric sensor (not shown). The biometric sensor may identify a customer based on a feature, such as an anatomical feature, of the customer. For example, the biometric sensor may be configured to identify the customer based on all or part of a face, a fingerprint, an iris, a retina a hand or any other suitable anatomical feature. The biometric sensor may identify the customer based on a behavioral feature such as a signature, facial recognition, eye or fingerprint pattern, voice, gait or any other suitable behavioral feature.

Document acceptor 208 may accept any suitable documents. For example, document acceptor 208 may accept envelopes, deposit forms, bills, checks or any other suitable documents. In some embodiments, document acceptor 208 may feed into a scanner that digitizes the documents for image-based transaction processing. Item dispenser 210 may dispense items. For example, item dispenser 210 may dispense bills, receipts, or tickets. Also, one skilled in the art will appreciate and understand that ATMs 200 may include additional, alternative, of fewer component parts; however, such components will be generally understood to those in the art, and therefore need not be discussed at length herein.

Security screen 212 may visually screen a surveillance device (not shown). The surveillance device may provide video information about individuals that are present near the ATM 200 and the conditions at the ATM 200 itself.

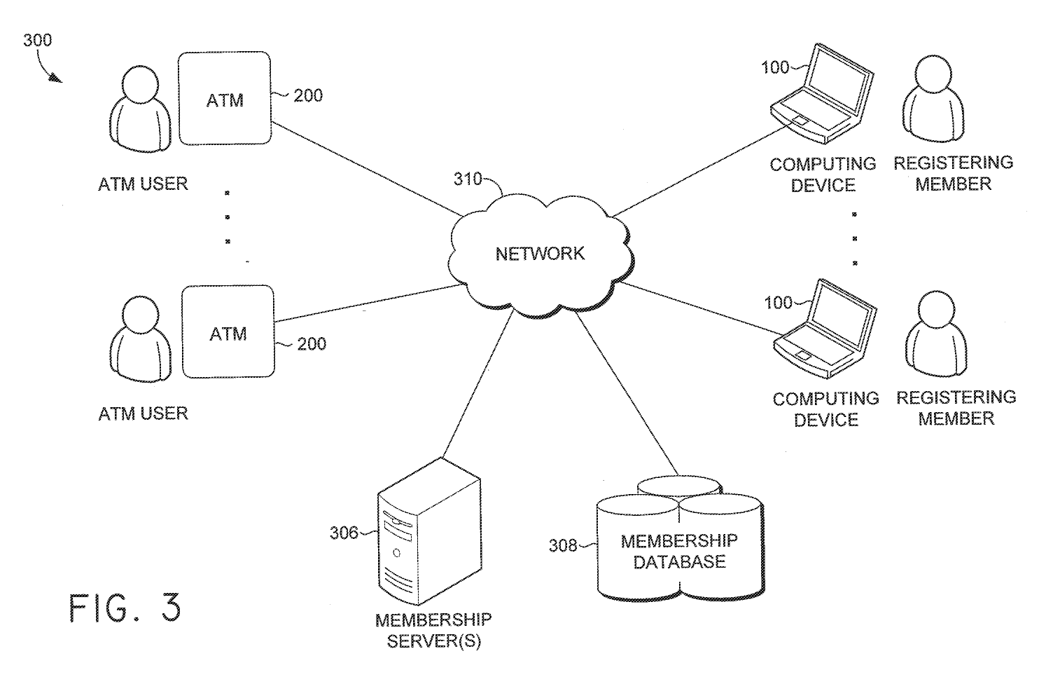

FIG. 3 is a block diagram of a networking environment 300 configured to manage a server-implemented ATM membership service that controls the charging of ATM surcharge fees across a selective collection of ATMs 200, according to one embodiment. Networking environment 300 involves multiple ATMs 200 and computing devices 100, case membership server(s) 306, and case card database cluster 308 that can communicate over a network 310. Computing devices 100 may be any type of computing device described above in reference to FIG. 1. By example, without limitation, computing devices 100 may each be a personal computer, desktop computer, laptop computer, handheld device, mobile phone, electronic tablet, or other personal computing device. In particular, computing devices 100 may be configured with web browsers capable of rendering web pages and accessing different user graphical user interfaces (GUIs).

Network 310 may include any computer network, for example the Internet, a private network, local area network (LAN), wide area network (WAN), or the like. One network 310 comprises a LAN networking environment, components may be connected to the LAN through a network interface or adapter. In an embodiment where the network 310 provides a WAN networking environment, components may use a modem to establish communications over the WAN. The network 310 is not limited, however, to connections coupling separate computer units. Instead, the network 310 may also include subsystems that transfer data between a server and the computing devices. For example, the network 310 may include a point-to-point connection.

Membership server 306 represents a server (or servers) configured to execute different software components. Membership server 306 includes a processing unit and computer-storage media storing instructions to register a registering user's account numbers into an ATM membership service that provides registered members with surcharge-free access to select ATMs 200. While membership server 306 is illustrated as a single box, one skilled in the art will appreciate that the campaign server 306 may, in fact, be scalable. For example, membership server 306 may include multiple servers operating various portions of software that collectively register a registering user into the ATM membership service.

Membership database cluster 308 represents one or more database servers configured to store and manage data associated with the ATM membership service. The database cluster 308 receives, stores, and tracks a registered member's account number along with beginning and ending dates of each member's registration in the ATM membership service. In one embodiment, the database cluster 308 stores a token that is based on 16-digit ATM card number of a registered member, a beginning date of the member's registration in the ATM membership service, and an ending date of the member's registration. The token, in one embodiment, is generated through application of an encryption algorithm to the 16-digit ATM card number to produce an 87-digit alphanumeric token that is stored on the database cluster 308. Embodiments are not limited to an 87-digit token, however, as virtually any tokenized value may be used to encode the 16-digit ATM card number. The encryption algorithm, in one embodiment, uses a non-reversible, one-way hashing, encryption, or tokenizing algorithm to generate the token. Creation and use of the token provides a level of Payment Card Industry (PCI) security that ensures the storage and tracking of ATM card numbers can be done so in a safe manner.

The ATM card holder's ATM and shopping behaviors may be captured and stored in the database cluster 308 in association with the token. For example, nearly every transaction (withdrawal, deposit, balance check) performed at the ATM may be recorded and linked to the token. The location and type of retailer in which the ATM is housed may also be captured, as may the time and dates of such member's ATM usage. Such information may provide a clearer picture of when and where the member shops for particular types of items.

In one embodiment, a registering member navigates to a web page or software application on a computing device 100 and submits the registering member's account number. The web page or application may present various payment and registration options, such as, for example but without limitation, how long the member wishes to participate in the ATM membership service, how the member wishes to pay for service, which ATM cards the member wishes to register, and the like. The registering member may then submit the entered information to the membership server 308 for registration in the ATM membership service. The membership server 306 creates a token of the submitted ATM card numbers and, if payment is processed, enrolls the registering member into the ATM membership service by storing the token and an indication of the membership timeframe. The token and membership timeframe are linked together in a database on the membership database cluster 308 to provide a registration of the ATM card into the ATM membership service.

Table A below illustrates an example of the information stored in such a database:

TABLE A
DATABASE OF MEMBERSHIP TOKENS

| | Membership | Membership |
|---|---|---|
| | Beginning | Ending |
| Token | Date | Date |
| 123456 . . . | Jan. 6, 2011 | Jan. 6, 2012 |
| 234567 . . . | Feb. 1, 2010 | Feb. 1, 2011 |
| 456789 . . . | Apr. 5, 2009 | May 5, 2009 |
| 80A7F8 . . . | Mar. 21, 2014 | Sep. 21, 2014 |
| 1A23B9 . . . | Sep. 12, 2013 | Sep. 12, 2014 |

As shown in Table A, the database includes a list of alphanumeric tokens for each ATM card participating in the ATM membership service. Linked to each token are beginning and ending membership dates indicating when the underlying ATM card of each token is allowed to use participating ATMs 200 in a surcharge free manner.

Tokens may be based on any account number associated with an ATM card and may be constructed through application of an encryption or hashing algorithm. In one embodiment, the token is created from the 16 digit ATM card number. Alternatively, in other embodiments, the token may be based on the BIN; PAN; checking, saving, or brokerage account number; debit or credit card number; or other identifying card or account number associated with a swiped credit or debit card. One skilled in the art will appreciate and understand that these account numbers may be retrieved from the magnetic strip of an ATM card, a chip on the ATM card, or through NFC with a mobile device (e.g., through via ApplePay, Google Wallet, or the like).

When a registered ATM card is used at a participating ATM 200, the membership server 308 intercepts, or obtains, the ATM card number from the participating ATM 200, tokenizes the ATM card number, and searches the database cluster 308 for the tokenized ATM card number. If the tokenized ATM card number is found in the database 308, the membership timeframe of the tokenized card number is checked in the database cluster 308 to determine whether the ATM card's membership in the ATM membership service is currently active. If membership is active, the membership server 306 transmits an instruction or otherwise controls the ATM 200 to not require a surcharge fee for the transaction at the ATM 200, e.g., the membership server may instruct the ATM 200 not to display a surcharge fee notification window. If membership it inactive or non-existent, the membership server 306 transmits an instruction or otherwise controls the ATM 200 to charge a surcharge fee for the ATM transaction, e.g., the membership server may instruct the ATM 200 to display a surcharge fee notification window.

Additionally, the membership server 306 may capture details from the ATM 200 about the financial transaction being performed by the ATM user. These details may include, for example but without limitation, the time/date of the transaction, the retailer in which the ATM is housed, the location of the ATM, the amount of the financial transaction, the type of account holder of the ATM card (e.g., gold account, platinum account, etc.), or the like. Moreover, the membership server 306 may provide some or all of such details to financial institutions, retailers, or managers of loyalty programs affiliated with the financial institutions. In one embodiment, the application server tracks the number of a specific bank's customers that are using a participating ATM 200, as such information may be helpful to persuade the bank to participate in the ATM membership service.

The application server also captures the amount of money the ATM users are saving by using the ATM membership service. This information can then be provided to the ATM users through various web pages, GUIs, or mobile applications, giving the users the ability to directly see the impact of the ATM membership service. Moreover, locations of participating ATMs 200 that are proximately close (e.g., within 2 miles) to non-participating ATMs at which the user conducted ATM transactions can be recommended to the user through a web page, application, or direct messaging (e.g., SMS, MMS, etc.) either periodically (daily, weekly, monthly, etc.) or whenever the user is detected to be within a specific distance of the non-participating ATM. For example, on the 15^{th} of the month, a user may receive a text message on her phone indicating the location of a participating ATM 200 when she is within 2 miles of a non-participating ATM she frequently uses in the middle of the month.

It should be noted that, in one embodiment, the registering users may register their ATM cards for participation in the ATM membership service at a computing device 100 that is separate and apart from the participating ATMs 200. The web page or application for registering ATM cards may be presented in a web browser of a laptop, personal computer, smartphone, mobile tablet, or the like. Such computing devices 100 may execute a standalone software application that allows the user to quickly register their ATM cards with the ATM membership service and/or quickly access key statistics about their membership in the service. For instance, the web page or software application may provide information to the ATM card holder as to the amount of money the user is saving by participating in the ATM membership service through not having to pay ATM surcharge fees.

The web page or software application may also recommend participating ATMs 200 that are within a particular proximity to non-participating ATMs at which the ATM card holder has previously or historically paid a surcharge fee. Retailers participating in loyalty programs may market specific products or services to the ATM card holder through the web page or software application based on the card holder's historical use of participating ATMs 200 or non-participating ATMs. Numerous other ways for interacting with the card holder based on his or her ATM usage may alternatively be used.

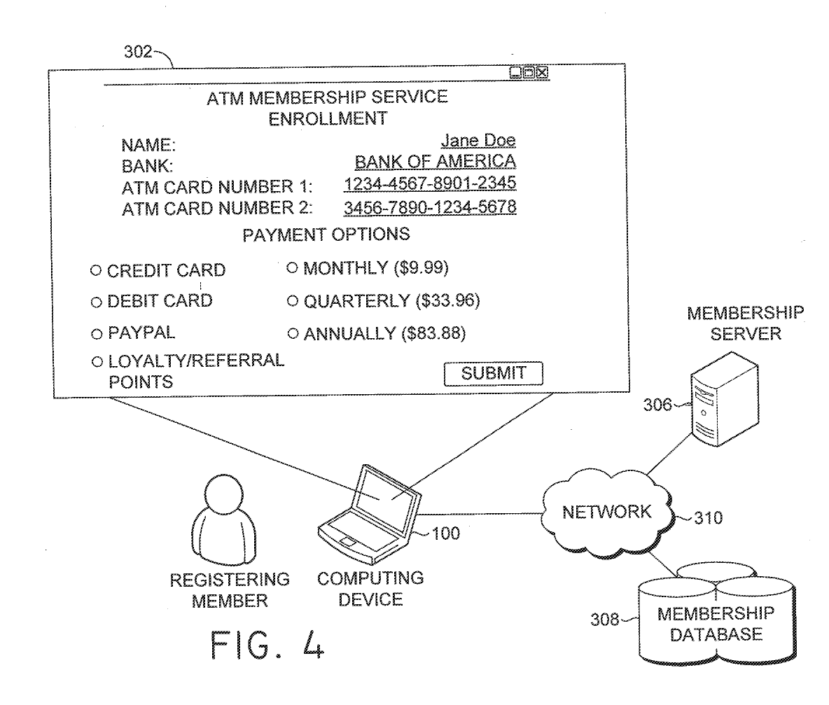

FIG. 4 illustrates a networked environment in which a registering member can register one or more ATM cards to participate in an ATM membership service, according to one embodiment. The registering member accesses a web page 302 or software application (e.g., iPhone, Android, BlackBerry, or Microsoft app) on computing device 100. The web page 302 prompts the registering member to enter their name, bank, and ATM card numbers. The web page 302 also prompts the registering member as to their preferred method of payment (e.g., credit card, debit card, PayPal, or use of retailer or bank loyalty points) and the frequency with which to pay (e.g., monthly, quarterly, annually). The registering member can then submit such information to the membership server 306, which in turn tokenizes the 16-digit ATM card numbers, processes payment, and stores the tokenized ATM card numbers in the membership database cluster 308 along with membership timeframe (beginning and ending dates) specifying the length of membership, thereby registering the registering member to participate in the ATM membership service for a specific timeframe.

Registered users can access participating ATMs 200 on a surcharge-free basis. In one embodiment, software executing on the participating ATMs 200 and non-participating ATMs, upon the swiping of an ATM card, direct the ATMs to communicate the 16 digit ATM card number to the membership server 306. In an alternative embodiment, the participating ATMs 200 and non-participating ATMs first tokenize or hash the 16 digit card number and send the resultant token to the membership server 306. The membership server 306 either tokenizes the received 16 digit ATM card to create a token or takes the received token and accesses the database cluster 308 to determine whether the token is linked to an active ATM card in the ATM membership service. To be an active card, the token must be listed as active and within the membership timeframe associated with the token. Use of a longer encrypted token (e.g., 87 alphanumeric characters) instead of the ATM card's 16 digit number of the ATM user's financial account number provides a layer of abstraction that reduces the risk that the user's ATM card or account number may be stolen while being communicated over the network 310.

If the ATM user is determined by the membership server 306 to be an active user (i.e., listed token that is within its active membership timeframe), one embodiment directs the membership server 306 to check whether the ATM the ATM user is accessing is a participating ATM 200 in the ATM membership service. If so, the membership server 306 instructs the user's ATM to not charge a surcharge fee for the ATM transaction. If not, the membership server 306 either directs the ATM to charge a surcharge fee for the transaction or just leaves the ATM to function regularly.

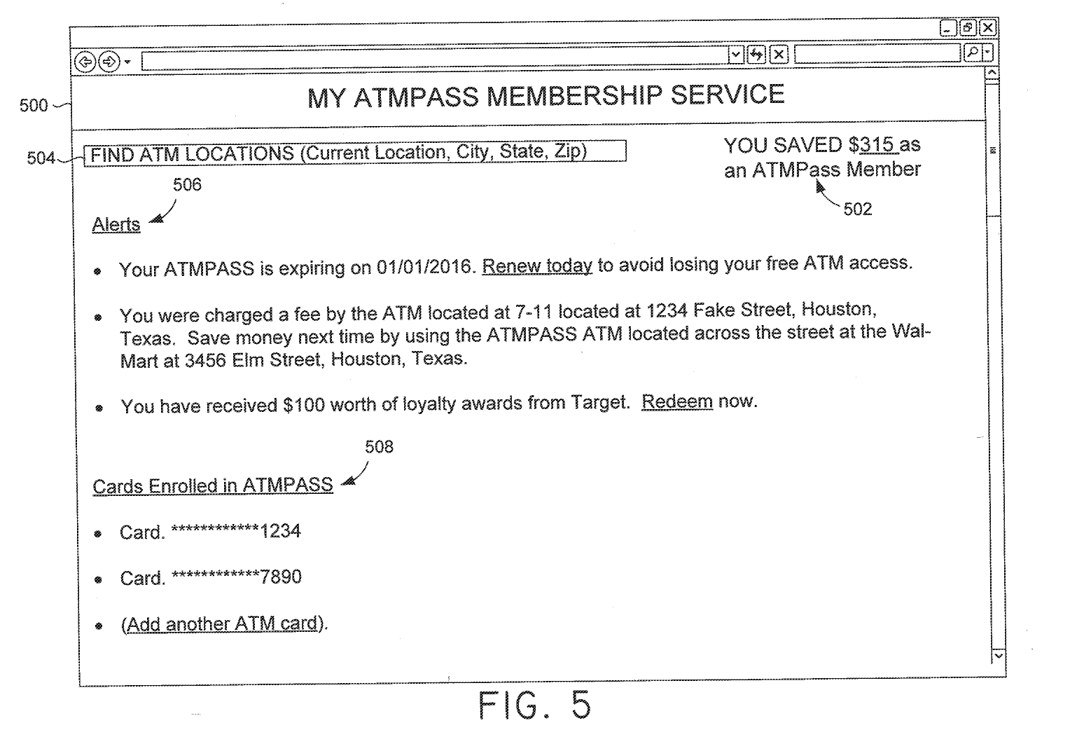

FIG. 5 illustrates a GUI of a web page 500 or application for monitoring usage of an ATM membership service, being administered and marketed as the service “ATMPASS,” according to one embodiment. A registered member can log in to the web page 500 and review information about their savings through the ATM membership service, registered ATM cards, and alerts based on their ATM usage. A first UI area 502 presents the savings the registered member has enjoyed through membership in the ATM membership service. This number can be calculated by the membership server 306 by taking the number of times the registered member used an ATM surcharge free during their membership timeframe multiplied by the surcharge fees at those participating ATMs 200 or standard surcharge fees for ATMs.

A text field 504 allows the registered user to search for participating ATMs 200 close to the registered member's current location or near a specific address, city, state, or zip code. This allows the registered member to quickly locate participating ATMs 200.

Alerts 506 are presented to indicate various information to the registered member. As illustrated, one alert 506 informs the member that their membership is expiring on a particular day and provides a link to an online renewal form. Another alert 506 indicates that the registered member was charged a fee for using a non-participating ATM that could have easily been avoided by using an alternative participating ATM 200 location within close proximity (e.g., within 2 miles) of the non-participating ATM. Another alert 506 indicates loyalty rewards accumulated by the registered member for use at a particular retailer and provides a link to the retailer for redemption of the loyalty rewards. Loyalty rewards may be accumulated through loyal use of participating ATMs 200 at the retailer or through non-ATM related activities, such as purchases at the retailer. Thus, the ATM membership service may be linked to other loyalty or reward programs that have nothing to do with ATM usage. Numerous other alerts may be created based on the registered member's ATM usage, spending habits, and/or financial transactions. For example, alerts 506 may be set to notify the registered member of special offers at stores in which the member has used an ATM, to indicate closer ATMs (participating or non-participating) to the user's place of business or home—as determined from the member's purchase history or account records, to indicate trends in the member's ATM usage history, to indicate trends in similarly profiled member's ATM usage history, to present relevant financial products (e.g., life insurance, disability insurance, IRAs, brokerages, 529 plans, etc.) based on the member's ATM usage and ATM transactions, to notify the member of potential security breaches at specific retailers where used ATMs are located, or similar other alerts 506. Alerts 506 may be based on additional personal and historical banking information of the registered members other than just their ATM usage. For example, alerts 506 may be based on the member's income level, direct deposit information, demographics, geographic location, marital status, age, employer, credit score, or other type of information typically gathered by a banking or financial institution providing ATM debit card services.

Web page 500 also informs the registered member of the ATM cards 508 that are registered with the ATM membership service. Options may be provided to delete or add additional ATM cards to the membership.

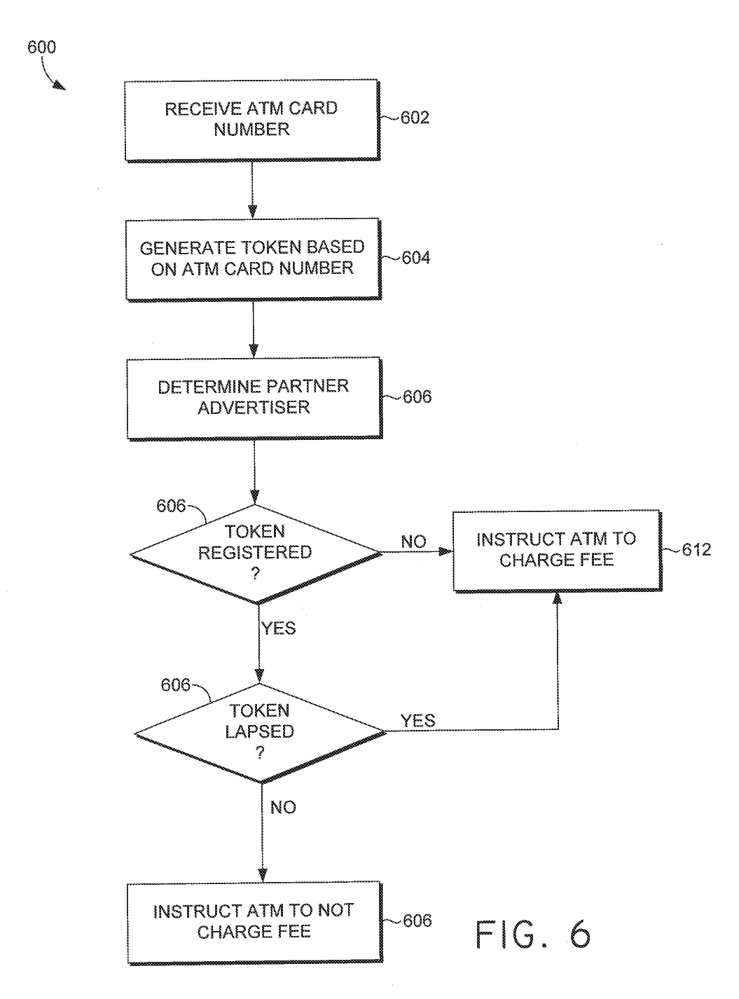

FIG. 6 illustrates a flowchart diagram of flow 600 for managing the charging of surcharge fees on a collection of participating ATMs in an ATM membership service, according to one embodiment. Initially, a participating ATM receives an ATM user's card number, for example from a magnetic strip on the back of the ATM card or from a chip on the card, as indicated at block 602. The ATM card number is transmitted to a membership server, which in turn tokenizes the ATM card number to create an alphanumeric token by applying a hashing or encryption algorithm to the ATM card number, as indicated at block 604. Alternatively, the ATM may tokenize the ATM card number and transmit the resultant token to the membership server. In one embodiment, the token is an 87-digit character alphanumeric token. Regardless of which device creates the token, the membership server determines whether the token is associated with a registered ATM card by checking a database of registered tokens in a database cluster to determine whether the received or generated token is registered in the database, as indicated at decision block 606. If the token is registered, the membership timeframe for the token is checked against, and if the current financial transaction is occurring within the membership timeframe—i.e., the timeframe has not lapsed—the membership server directs the ATM to not charge the ATM user a surcharge fee, as indicated at block 608. If, however, the token is not listed in the database of registered tokens or the ATM transaction is occurring outside of the membership timeframe for the token, the membership server directs the ATM to charge the ATM user a surcharge fee, as indicated at block 610.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated by and is within the scope of the claims.

What is claimed is:

1. One or more computer storage media having computer-executable instructions embodied thereon that, when executed, perform a method for controlling the presentation of a user interface (UI) window for charging a transaction surcharge fee on an automated teller machine (ATM), the method comprising:
receiving an ATM card number and a date of a requested ATM transaction;
creating an alphanumeric token through application of a hashing or encryption algorithm to the ATM card number;
determining whether the token is associated with a registered ATM card in an ATM membership service that provides surcharge-free usage of the ATM;
determining whether the date of the requested ATM transaction is within a membership timeframe associated with the token; and
based on the token being registered with the ATM membership service and the date of the requested ATM transaction being within the membership timeframe associated with the token, directing the ATM to carry out the transaction without payment of a surcharge fee.

2. The one or more computer storage media of claim 1, wherein the ATM card number comprises a sixteen digit debit or credit card number.

3. The one or more computer storage media of claim 1, wherein the ATM card number comprises a bank identification number (BIN).

4. The one or more computer storage media of claim 1, wherein the ATM card number comprises a primary account number (PAN) associated with a bank account.

5. The one or more computer storage media of claim 1, wherein the ATM card number comprises a 16 digit gift card number.

6. The one or more computer storage media of claim 1, wherein the alphanumeric token comprises an 87 character alphanumeric tokenized rendition of the ATM card number.

7. The one or more computer storage media of claim 1, wherein the hashing or encryption algorithm uses a private key.

8. The one or more computer storage media of claim 1, further comprising directing the ATM to charge the surcharge fee upon determination that the token is not registered with the ATM membership service.

9. The one or more computer storage media of claim 1, further comprising directing the ATM to charge the surcharge fee upon determination that the membership timeframe associated with the token has lapsed.

10. The one or more computer storage media of claim 1, wherein the alphanumeric token is created on the ATM and transmitted to a membership server.

11. A method for controlling the presentation of a user interface (UI) window for charging a transaction surcharge fee on an automated teller machine (ATM), the method comprising:
receiving an ATM card number and a date of a requested ATM transaction;
creating an alphanumeric token through application of a hashing or encryption algorithm to the ATM card number;
determining whether the token is associated with a registered ATM card in an ATM membership service that provides surcharge-free usage of the ATM;
determining whether the date of the requested ATM transaction is within a membership timeframe associated with the token; and
if the token has not been registered with the ATM membership service or the date of the requested ATM transaction is outside the membership time frame associated with the token, directing the ATM to carry out the transaction only upon acknowledgment to pay a surcharge fee.

12. The method of claim 11, further comprising: if the token has been registered with the ATM membership service and the date of the requested ATM transaction is within the membership time frame associated with the token, directing the ATM to carry out the transaction without payment of the surcharge fee.

13. The method of claim 11, wherein the ATM card number comprises a sixteen digit debit or credit card number.

14. The method of claim 11, wherein the ATM card number comprises a bank identification number (BIN).

15. The method of claim 11, wherein the ATM card number comprises a primary account number (PAN) associated with a bank account.

16. The method of claim 11, wherein the ATM card number comprises a general purpose reloadable or prepaid card.

17. The method of claim 11, wherein the alphanumeric token comprises an 87 character alphanumeric tokenized rendition of the ATM card number.

18. The method of claim 11, wherein the hashing or encryption algorithm uses a private key.

19. A system, comprising:
a plurality of automated teller machines (ATMs) configured to receive ATM card numbers from ATM users; and
one or more servers configured to store membership information in an ATM membership service for a plurality of ATM users, wherein the membership information for each ATM user comprises a token value that is generated from a sixteen digit ATM card number and a membership timeframe during which the sixteen digit ATM card number enrolled in the ATM membership service,
wherein the one or more servers are configured to receive each of the ATM card numbers from the plurality of ATMs and control charging of surcharge fees on the plurality of ATMs based on valid enrollment of the ATM card numbers in the ATM membership service.

20. The system of claim 19, wherein the one or more servers are configured to control each of the plurality of ATMs to not prompt an ATM user to pay a surcharge fee for ATM usage whenever the corresponding ATM card from the ATM user is enrolled in the ATM membership service and the membership timeframe of the ATM card has not lapsed.
